(19) United States
(12) Patent Application Publication
(10) Pub. No.: US 2006/0173786 A1
(43) Pub. Date: Aug. 3, 2006

(54) Medium content protection method

(75) Inventors: Yi-Kai Chen, Taipei (TW); Chen-Chia Chang, Taipei (TW)

Correspondence Address: BEVER HOFFMAN & HARMS, LLP;TRI-VALLEY OFFICE, 1432 CONCANNON BLVD., BLDG. G, LIVERMORE, CA, 94550, US

(73) Assignee: Ulead Systems, Inc., Taipei (TW)

(21) Appl. No.: 11/196,566

(22) Filed: Aug. 2, 2005

(30) Foreign Application Priority Data
Feb. 2, 2005 (TW) 094103276

(51) Int. Cl. G06Q 99/00

(52) U.S. Cl. 705/58

(57) ABSTRACT

In the present invention, a medium content protection method for protecting a content of a first storage medium having a first manufacture information is provided. The method includes steps of pre-recording a first identification datum into the first manufacture information, providing a second storage medium having a second manufacture information, reading a second identification datum from the second manufacture information and comparing the second identification datum with the first identification datum, determining the second storage medium as being illegally reproduced when the second identification datum is different from the first identification datum, and determining the second storage medium as the first storage medium and performing a specific step when the second identification datum is identical to the first identification datum.

### FIELD OF THE INVENTION

The present invention relates to a protection method, and more particularly to a medium content protection method.

### BACKGROUND OF THE INVENTION

Due to the popularity of pirated software, the medium content protection would be performed while the software or digital contents are issued. Although the medium content protection will cause the inconvenience for the legal user, it is still necessary in order to protect the software from being pirated.

Currently, there are several medium content protection methods in use. One of them is to reserve some errors on a specific segment of the storage medium, such as a CD or DVD. These errors are unable to be reproduced onto a new storage medium when an illegal user intends to reproduce the storage medium with a burner. Therefore, when the illegally reproduced storage medium is verified by the protection software, it will not be installed or executed since these errors are not detected.

Please refer to FIG. 1, which shows the flowchart of another medium protection method in the prior art. At first, the user has to enter the serial number of the storage medium (step 11). Then, the verifying program is performed to verify whether the serial number is correct (step 12). If the serial number is correct, the storage medium will be installed or executed (step 13). Contrarily, the verifying program will be terminated if the serial number is incorrect.

In the above medium protection method, the user could still execute the storage medium illegally only by reproducing it and recording its serial number. Moreover, during the installation or execution process, the user needs to enter the correct serial number of the storage medium to identify whether it is legally authorized. Even if the storage medium is legally authorized, it is unable to be installed or executed when the user loses the serial number. Besides, the verification for the serial number would be incorrect if the user misspells the long serial number. For re-verification, it is necessary for the user to re-enter the long serial number. This causes a nuisance for the user.

From the above descriptions, it is known that how to develop a medium content protection method without the need for entering the serial number has become a major problem to be solved. In order to overcome the drawbacks in the prior art, an improved medium content protection method is provided. The particular design in the present invention not only solves the problems described above, but also is easy to be implemented. Thus, the invention has the utility for the industry.

### SUMMARY OF THE INVENTION

In accordance with one aspect of the present invention, a medium content protection method is provided. The provided method utilizes the identification data pre-recorded in the manufacture information of the storage medium as the basis for the medium content protection. Thus, it is unnecessary for the user to enter the serial number of the storage medium during the installation or execution process.

In accordance with another aspect of the present invention, a medium content protection method for protecting a content of a first storage medium having a first manufacture information is provided. The method includes steps of pre-recording a first identification datum into the first manufacture information, providing a second storage medium having a second manufacture information, reading a second identification datum from the second manufacture information and comparing the second identification datum with the first identification datum, determining the second storage medium as being illegally reproduced when the second identification datum is different from the first identification datum, and determining the second storage medium as the first storage medium and performing a specific step when the second identification datum is identical to the first identification datum.

Preferably, the first storage medium is legally authorized.

Preferably, the first storage medium is one of a CD and a DVD.

Preferably, the content of the first storage medium is one of a software, a multimedia datum and a file.

Preferably, the specific step is performed by one of executing the software and playing the multimedia datum.

Preferably, the first identification datum is one of a serial number of the first storage medium and a combination of data.

Preferably, the first identification datum is pre-recorded into the first manufacture information by the manufacturer of the first storage medium.

Preferably, the second storage medium is one of a CD and a DVD.

Preferably, the second identification datum is one of a serial number of the second storage medium and a combination of data.

Preferably, the second identification datum in the second manufacture information is read by a reading device.

Preferably, the reading device is one of a CD player and a DVD player.

Preferably, the second identification datum is compared with the first identification datum via a verifying program.

In accordance with a further aspect of the present invention, a medium content protection method for verifying whether a storage medium having a manufacture information is legally authorized is provided. The method includes steps of reading an identification datum from the manufacture information of the storage medium, determining the storage medium as being legally authorized when the identification datum is legal and then performing a specific task, and determining the storage medium as being illegally reproduced when the identification datum is illegal.

Preferably, the storage medium is one of a CD and a DVD.

Preferably, the storage medium has a content being one of a software, a multimedia datum and a file.

Preferably, the specific task is performed by one of executing the software and playing the multimedia datum.

Preferably, the identification datum is one of a serial number of the storage medium and a combination of data.

Preferably, the identification datum is pre-recorded into the manufacture information by the manufacturer of the storage medium.

Preferably, the identification datum in the manufacture information of the storage medium is read by a reading device.

Preferably, the reading device is one of a CD player and a DVD player.

Preferably, the identification datum is read via a verifying program.

In accordance with further another aspect of the present invention, a medium content protection method for verifying whether a storage medium having a manufacture information is legally authorized is provided. The method includes steps of providing the storage medium into a reading device, running a verifying program, reading the manufacture information by the reading device in response to a request from the verifying program, sending the manufacture information from the reading device to the verifying program, processing and verifying the manufacture information by the verifying program, determining the storage medium as being legally authorized when the manufacture information is legal and then performing a specific task, and determining the storage medium as being illegally reproduced when the manufacture information is illegal and then finishing the method.

Preferably, the storage medium is one of a CD and a DVD.

Preferably, the storage medium has a content being one of a software, a multimedia datum and a file.

Preferably, the specific task is performed by one of executing the software and playing the multimedia datum.

Preferably, the reading device is one of a CD player and a DVD player.

Preferably, the manufacture information is pre-recorded into the storage medium by the manufacturer of the storage medium.

The above objects and advantages of the present invention will become more readily apparent to those ordinarily skilled in the art after reviewing the following detailed descriptions and accompanying drawings, in which:

### BRIEF DESCRIPTION OF THE DRAWINGS

FIG. 1 is a flowchart of the medium protection method in the prior art;

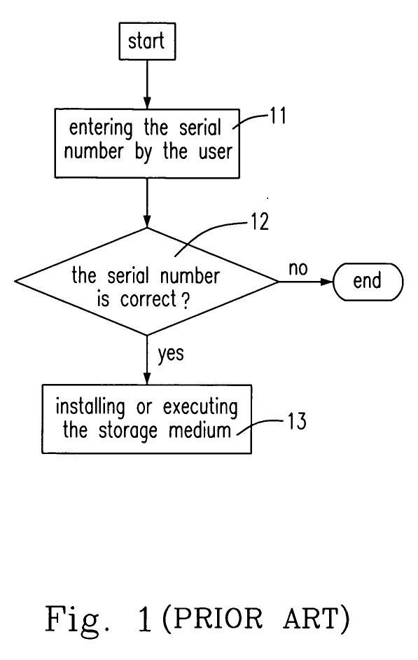

FIG. 2 is a diagram showing the structure of the medium content protection according to a preferred embodiment of the present invention; and

FIG. 3 is a flowchart of the medium content protection method according to a preferred embodiment of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for the purposes of illustration and description only; it is not intended to be exhaustive or to be limited to the precise form disclosed.

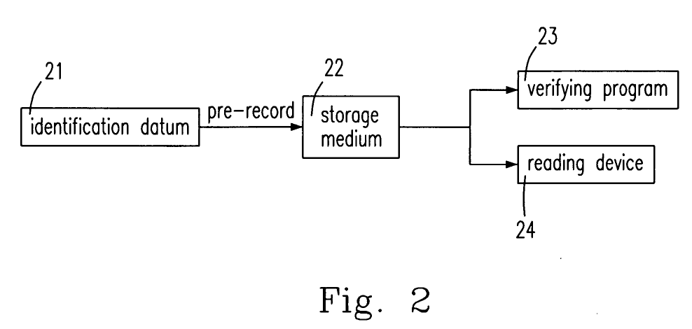

Please refer to FIG. 2, which shows the structure of the medium content protection according to a preferred embodiment of the present invention. The structure includes an identification datum 21, a storage medium 22, a verifying program 23 and a reading device 24. The identification datum 21 is pre-recorded in the manufacture information of the storage medium 22 as the basis for the medium content protection. The verifying program 23 is used for verifying the storage medium 22 to identify whether the storage medium 22 is legally authorized. The reading device 24 is used for reading the manufacture information of the storage medium 22 in response to the command from the verifying program 23, and then sending the manufacture information back to the verifying program 23 for further process and verification. The storage medium 22 could be performed or played only when determined as being legally authorized. If the storage medium 22 fails to pass the verification, it would be determined as being illegally reproduced and then the verifying program is terminated.

Preferably, the storage medium 22 can be a CD or a DVD storing the software or the multimedia data. The identification datum 21 can be the serial number of the storage medium 22 or the combination of any data forms. Moreover, the reading device 24 can be a CD player, a DVD player or any other devices capable of reading data.

Since the manufacture information could only be pre-recorded by the manufacturer of the storage medium 22, the correct identification datum is unable to be read from the manufacture information of an illegally reproduced storage medium. This prevents the illegally reproduced storage medium from being installed or performed.

Through the medium content protection method of the present invention, the software company could cooperate with the manufacturer of the storage medium 22 to have the identification datum 21 pre-recorded within a certain filed of the manufacture information of the storage medium 22 during its manufacturing process. After pre-recorded with the identification datum 21, the storage medium 22 becomes the one and only legally authorized storage medium. In this way, whether the storage medium 22 is legally authorized or not could be determined by reading and verifying the identification datum 21 of the storage medium 22. Because the manufacture information could only be pre-recorded by the manufacturer of the storage medium 22, the identification datum 21 thereof is unable to be reproduced even if the storage medium 22 has been illegally reproduced. Thus, the illegally reproduced storage medium is unable to pass the verification. This prevents the illegally reproduced storage medium from being performed or played.

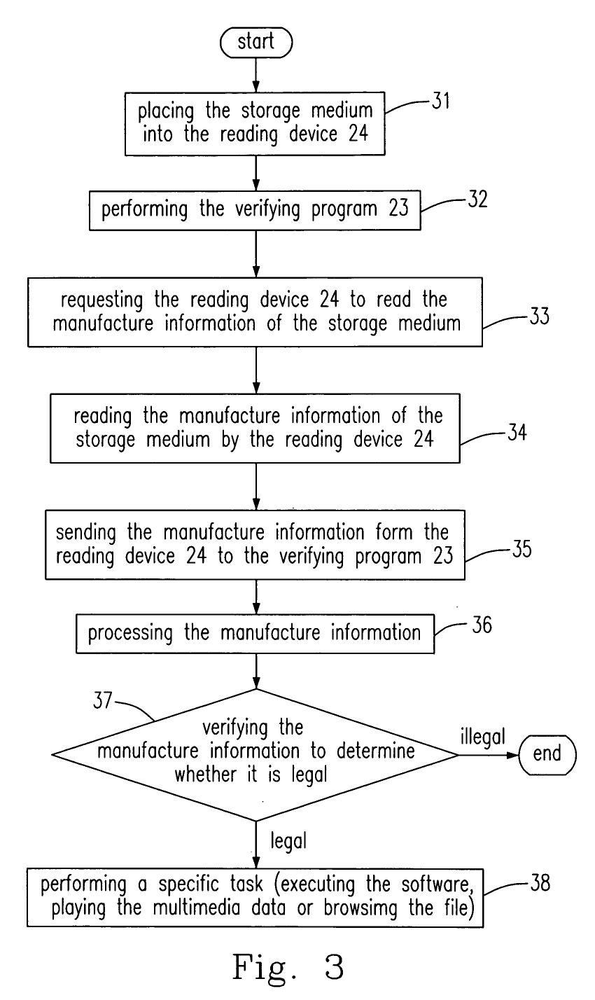

Please refer to FIG. 2 and FIG. 3. FIG. 3 shows the flowchart of the medium content protection method according to a preferred embodiment of the present invention. The steps of the medium content protection method are as follows.

At first, the identification datum 21 is pre-recorded in the manufacture information of the storage medium 22 to produce a legally authorized storage medium. During the verification for a certain storage medium, the storage medium is placed into the reading device 24 (step 31) first, and then the verifying program 23 is performed (step 32). Next, the verifying program 23 requests the reading device 24 to read the manufacture information of the storage medium (step 33). Then, the manufacture information of the storage medium is read by the reading device 24 (step 34). Afterwards, the manufacture information is sent from the reading device 24 to the verifying program 23 (step 35), and then the manufacture information is processed (step 36) and verified by the verifying program 23 to determine whether it is legal (step 37). If the manufacture information is legal, i.e. it is identical to that of the legally authorized storage medium, the storage medium is determined as the legally authorized storage medium, and then a specific task, such as executing the software, playing the multimedia data or browsing the file, is performed (step 38). However, if the manufacture information is illegal, i.e. it is different from that of the legally authorized storage medium, the storage medium is determined as being illegally reproduced, and then the verifying program 23 is terminated.

In conclusion, the present invention utilizes the identification data pre-recorded in the manufacture information of the storage medium as the basis for the medium content protection. Thus, it is unnecessary for the user to enter the serial number of the storage medium during the installation or execution process. Accordingly, the present invention can effectively solve the problems and drawbacks in the prior art, and thus it fits the demand of the industry and is industrially valuable.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A medium content protection method for protecting a content of a first storage medium having a first manufacture information, comprising steps of:
pre-recording a first identification datum into said first manufacture information;
providing a second storage medium having a second manufacture information;
reading a second identification datum from said second manufacture information and comparing said second identification datum with said first identification datum;
determining said second storage medium as being illegally reproduced when said second identification datum is different from said first identification datum; and
determining said second storage medium as said first storage medium and performing a specific step when said second identification datum is identical to said first identification datum.

2. The method as claimed in claim 1, wherein said first storage medium is legally authorized.

3. The method as claimed in claim 1, wherein said first storage medium is one of a CD and a DVD.

4. The method as claimed in claim 3, wherein said content of said first storage medium is one of a software, a multimedia datum and a file.

5. The method as claimed in claim 4, wherein said specific step is performed by one of executing said software and playing said multimedia datum.

6. The method as claimed in claim 1, wherein said first identification datum is one of a serial number of said first storage medium and a combination of data.

7. The method as claimed in claim 1, wherein said first identification datum is pre-recorded into said first manufacture information by a manufacturer of said first storage medium.

8. The method as claimed in claim 1, wherein said second storage medium is one of a CD and a DVD.

9. The method as claimed in claim 1, wherein said second identification datum is one of a serial number of said second storage medium and a combination of data.

10. The method as claimed in claim 1, wherein said second identification datum in said second manufacture information is read by a reading device.

11. The method as claimed in claim 10, wherein said reading device is one of a CD player and a DVD player.

12. The method as claimed in claim 1, wherein said second identification datum is compared with said first identification datum via a verifying program.

13. A medium content protection method for verifying whether a storage medium having a manufacture information is legally authorized, comprising steps of:
reading an identification datum from said manufacture information of said storage medium;
determining said storage medium as being legally authorized when said identification datum is legal and then performing a specific task; and
determining said storage medium as being illegally reproduced when said identification datum is illegal.

14. The method as claimed in claim 13, wherein said storage medium is one of a CD and a DVD.

15. The method as claimed in claim 13, wherein said storage medium has a content being one of a software, a multimedia datum and a file.

16. The method as claimed in claim 15, wherein said specific task is performed by one of executing said software and playing said multimedia datum.

17. The method as claimed in claim 13, wherein said identification datum is one of a serial number of said storage medium and a combination of data.

18. The method as claimed in claim 13, wherein said identification datum is pre-recorded into said manufacture information by a manufacturer of said storage medium.

19. The method as claimed in claim 13, wherein said identification datum in said manufacture information of said storage medium is read by a reading device.

20. The method as claimed in claim 19, wherein said reading device is one of a CD player and a DVD player.

21. The method as claimed in claim 13, wherein said identification datum is read via a verifying program.

22. A medium content protection method for verifying whether a storage medium having a manufacture information is legally authorized, comprising steps of:
providing said storage medium into a reading device;
running a verifying program;
reading said manufacture information by said reading device in response to a request from said verifying program;
sending said manufacture information from said reading device to said verifying program;
processing and verifying said manufacture information by said verifying program;
determining said storage medium as being legally authorized when said manufacture information is legal and then performing a specific task; and
determining said storage medium as being illegally reproduced when said manufacture information is illegal and then terminating said verifying program.

23. The method as claimed in claim 22, wherein said storage medium is one of a CD and a DVD.

24. The method as claimed in claim 22, wherein said storage medium has a content being one of a software, a multimedia datum and a file.

25. The method as claimed in claim 24, wherein said specific task is performed by one of executing said software and playing said multimedia datum.

26. The method as claimed in claim 22, wherein said reading device is one of a CD player and a DVD player.

27. The method as claimed in claim 22, wherein said manufacture information is pre-recorded into said storage medium by a manufacturer of said storage medium.
